(19) United States
(12) Patent Application Publication
(10) Pub. No.: US 2003/0115784 A1
(43) Pub. Date: Jun. 26, 2003

(54) Figurative print on a plane print carrier and use of such figurative print

(76) Inventor: Erik Brogaard Thomsen, Vejle (DK)

Correspondence Address: Gerald Levy, Pitney, Hardin, Kipp & Szuch, LLP, 685 Third Avenue, New York, NY, 10017, US

(21) Appl. No.: 10/364,878

(22) Filed: Feb. 12, 2003

Related U.S. Application Data
(63) Continuation of application No. 09/381,771, filed on Oct. 26, 1999.

(30) Foreign Application Priority Data
Mar. 25, 1997 (DK) 9700140

(51) Int. Cl. G09F 7/00

(52) U.S. Cl. 40/596

(57) ABSTRACT

The invention relates to a figurative print for a plane print carrier. In a preferred embodiment, the figurative print comprises a primary, a secondary, and a tertiary figurative element. Each of the three elements shows an angular displacement of between 0° and 90° in to a perpendicular view of the figurative print on the plane print carrier so that the figurative print appears with a special effect, when the print is viewed from an oblique position relative to a perpendicular viewing.

### BACKGROUND OF THE INVENTION

The present invention relates to a figurative print on a plane print carrier, and which print is plane and comprises a primary figurative element depicting an information in two dimensions.

It is known to apply a figurative print, like an advertising print, on a plane print carrier, like a football field. The print is depicted in two dimensions, like the print will normally appear on a plane print carrier. Thus, the print is intended to be viewed perpendicularly to the plane print carrier such as a lawn. Especially in connection with football fields, this is an advantage so that many of the spectators at the football match may see the advertising print. However, it is a drawback that a spectator like a television viewer of a television transmitted football match does not get the full benefit from the advertising value of the advertising print, as a given TV camera is not necessarily placed and views the advertising print in such a way that the advertising print appears in the best possible way for a television viewer.

It is the purpose of the present invention to provide a figurative print which is applied to a plane print carrier so that the print appears in the best possible way for a chosen viewer.

This purpose is achieved with a figurative print which is peculiar in that the primary figurative element as seen in a direction perpendicular to the plane print carrier is applied with an angular displacement ax of the figurative element as compared to a perpendicular view of the figurative element on the plane print carrier, and that the angular displacement α is equal to an angle between a perpendicular view of the print and an oblique view of the print relative to the perpendicular view.

The oblique viewing of the print may correspond to an angle at which a TV camera is placed as compared to a perpendicular viewing of the print. The oblique viewing of the print may also correspond to an angle that e.g. car drivers on a road pass as seen in relation to a perpendicular viewing of the print. The oblique viewing of the print may be any angle so that the print appears in the best possible way before a viewer in a given position relative to the print, i.e. corresponding to a perpendicular view facing the viewer in question.

In a preferred embodiment of the figurative print according to the invention, the print is peculiar in that the print comprises a secondary figurative element depicting the information in a third dimension, that the secondary figurative element as seen in a direction perpendicular to the plane print carrier is applied with an angular displacement β of the figurative element as compared to a perpendicular view of the figurative element on the plane print carrier, and that the angular displacement β is equal to an angle between a perpendicular view of the print and an oblique view of the print relative to the perpendicular view.

By imparting a secondary figurative element to the print it is possible to achieve a three-dimensional effect of the print for the viewer in question. As the primary figurative element, the secondary figurative element is subjected to an angular displacement which results in a three-dimensional effect that is the best possible for the viewer in question, i.e. a three-dimensional effect corresponding to a perpendicular viewing of the print.

A secondary figurative element may be a shadow effect, a relief effect or another three-dimensional effect of the primary figurative element. In alternative embodiments the print is provided with a tertiary figurative element that may comprise a foreground, a background or a frame.

The print according to the invention may be applied directly to the plane print carrier by spraying ink on the plane print carrier or in another way. The print according to the invention may also be applied to the plane print carrier by making the print on a carrying medium like a paper web, and that the carrying medium subsequently is applied to the plane print carrier, e.g. by pasting.

### DESCRIPTION OF THE DRAWING

The invention will be described in the following with reference to the attached drawing, in which

FIG. 1 is a perspective view of a best possible viewing of the print according to the invention,

FIG. 2 is a perspective view of a very inferior viewing of the print according to the invention,

FIG. 3 is a plane view of a print according to the invention.

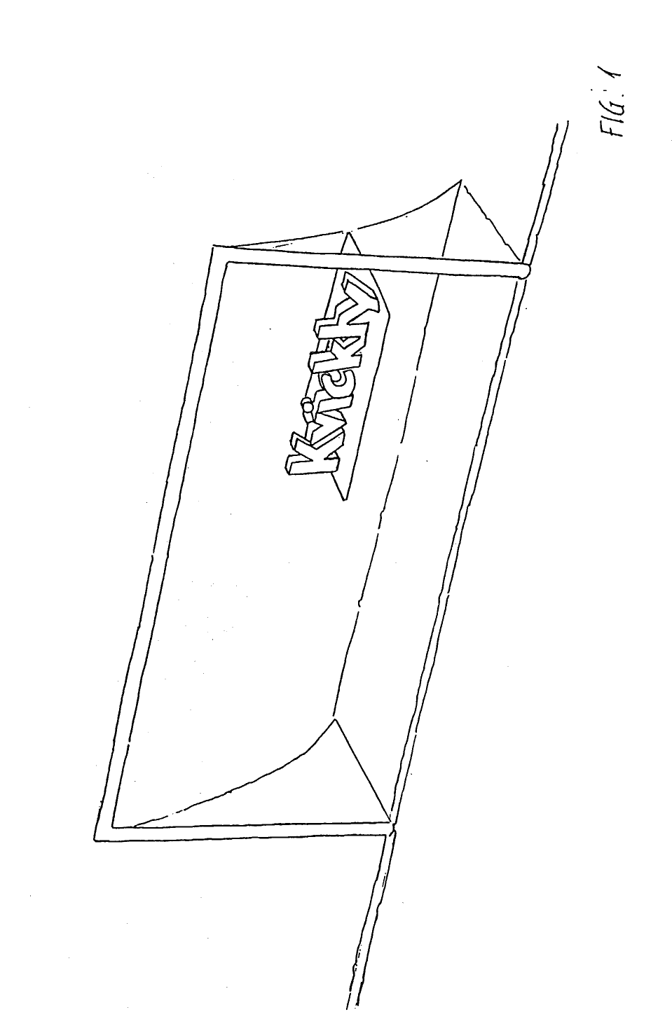

FIG. 1 shows how a print according to the invention will be viewed by a viewer that is positioned in the best possible way for viewing the print. The print shows the mark Kvickly, which in Denmark is a tradename for conveniences sold by Fællesforeningen for Danrnarks Brugsforeninger, the Danish Co-operative Wholesale Society. The print is illustrated in a situation, where the print is applied to a football field behind a football goal.

The print consists of a first figurative element which is toned grey and which constitutes the word part, Kvickly, a secondary figurative element which is black and which gives a depth of the word part, Kvickly, and a tertiary figurative element which is white and which constitutes a background for the primary and the secondary figurative element.

The print is applied with angular displacements relative to a perpendicular view of the primary and the secondary figurative element so that the primary figurative element and the secondary figurative element in combination cause the mark Kvickly to appear as standing up perpendicularly on the football field and with a depth perpendicular to a back line behind the football goal. The print is applied with angular displacements relative to a perpendicular view of the tertiary figurative element so that the background appears plane with the football field and rectangularly with sides that are perpendicular and parallel, respectively, with the back line behind the football goal.

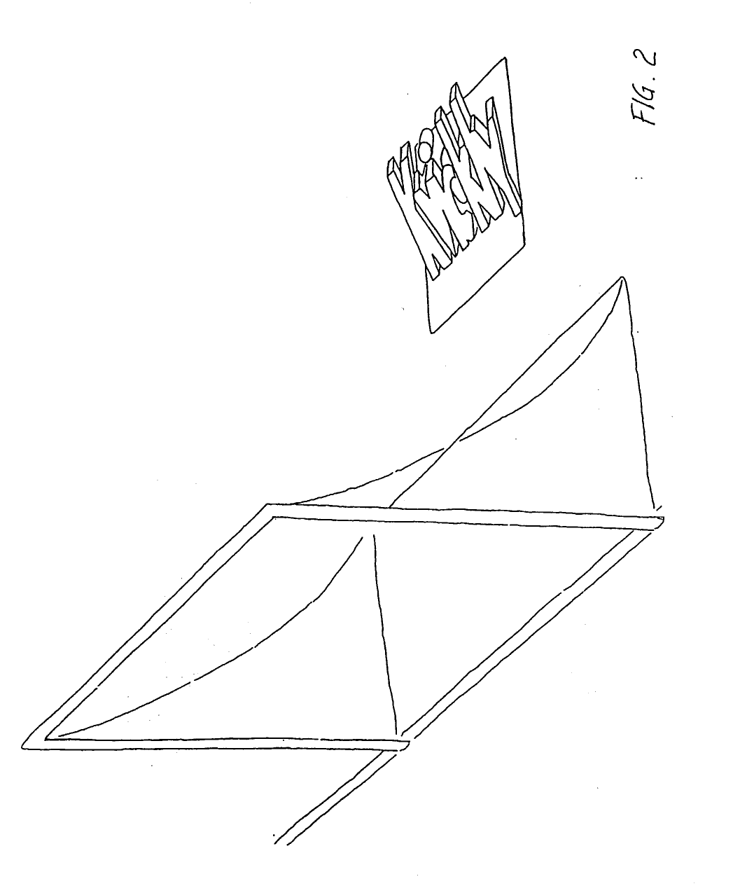

FIG. 2 shows how a print according to the invention will be viewed by a viewer who is positioned very inferiorly in relation to a viewing of the print. It appears that the print does not achieve the same effect as if viewed from a position corresponding to FIG. 1. Viewing as in FIG. 2 is actually worse than viewing of a print that is plane with the football field, and which is depicted as viewed perpendicularly and seen perpendicularly on the football field. The print according to the invention is, however, intended to be viewed by a viewer in a given position in relation to the print, which position is different from the position in FIG. 2 and equal to the position in FIG. 1.

The print according to the invention is therefore intended to make allowance for a viewer viewing the print from a given position relative to the print which is an oblique viewing of the print compared to the perpendicular viewing of the print. The print may thus be indended to make allowance for a television viewer of a football match viewing the print from a position of a TV camera or to make allowance for a car driver in front of a company domicile viewing the print from a position on a road.

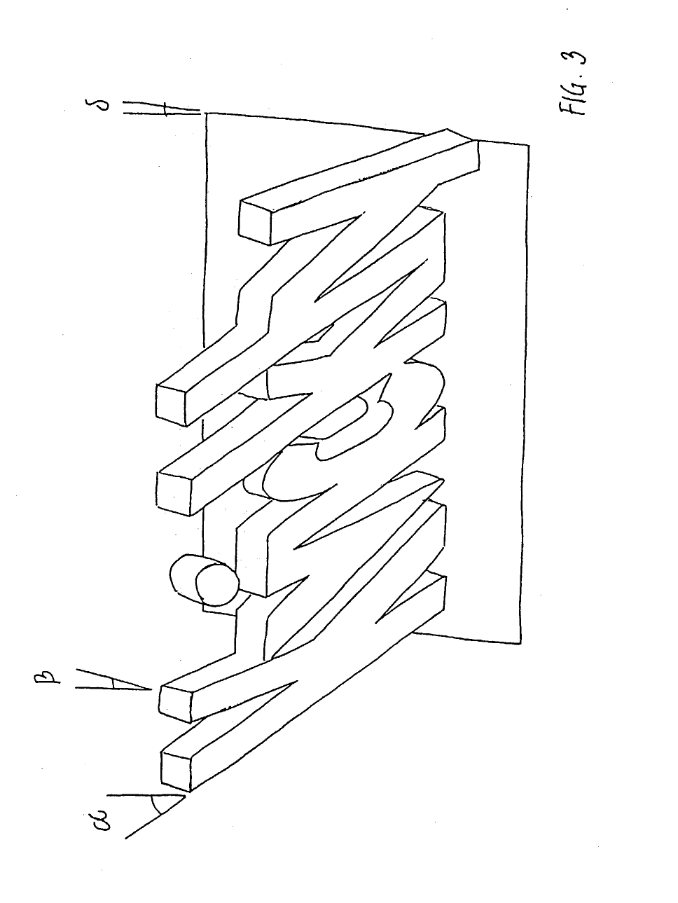

FIG. 3 shows a plane view of the print as it appears when the print is viewed perpendicularly and seen perpendicularly on the plane of the paper. The print comprises a primary figurative element that is toned dark grey, a secondary figurative element that is black, and a tertiary figurative element that in the shown view is toned light grey.

The first figurative element is directed at an angle a which in the shown view is about 35° relative to an axis A indicating a perpendicular view of the primary figurative element. The second figurative element is directed at an angle β which in the shown view is about 20° relative to the axis A which indicates the perpendicular view of the secondary figurative element. The tertiary figurative element is directed at an angle δ which in the shown view is about 5° relative to the axis A indicating the perpendicular view of the tertiary figurative element.

The angles α, β, and δ may vary arbitrarily between 0° and 90°. It depends completely on the position of the viewer in relation to the position of the print on the plane print carrier. The plane print carrier to which the figurative print is applied may be a ground surface such as a lawn, a road way like a parking lot, a house front like a company domicile, a transport means like a bus, or even further applications.

It will be possible to use print according to the invention consisting of a number of the primary, secondary and tertiary figurative elements.

1. A figurative print on a plane print carrier, and which print is plane and comprises a primary figurative element depicting an information in two dimensions, characterised in that the primary figurative element as seen in a direction perpendicular to the plane print carrier is applied with an angular displacement α of the figurative element as compared to a perpendicular view of the figurative element on the plane print carrier, and that the angular displacement α is equal to an angle between a perpendicular view of the print and an oblique view of the print relative to the perpendicular view.

2. A figurative print according to claim 1, characterised in that the print comprises a secondary figurative element depicting the information in a third dimension, that the secondary figurative element as seen in a direction perpendicular to the plane print carrier is applied with an angular displacement β of the figurative element as compared to a perpendicular view of the figurative element on the plane print carrier, and that the angular displacement β is equal to an angle between a perpendicular view of the print and an oblique view of the print relative to the perpendicular view.

3. A figurative print according to claim 2, characterised in that the secondary figurative element is a shadow of the primary figurative element.

4. A figurative print according to claim 2, characterised in that the secondary figurative element is a relief of the primary figurative element.

5. A figurative print according to any of the preceding claims, characterised in that the print comprises a tertiary figurative element depicting surroundings of the primary and secondary figurative element, that the tertiary figurative element as seen in a direction perpendicular to the plane print carrier is applied with an angular displacement δ of the figurative element as compared to a perpendicular view of the figurative element on the plane print carrier, and that the angular displacement δ is equal to an angle between a perpendicular view of the print and an oblique view of the print relative to the perpendicular view.

6. A figurative print according to claim 5, characterised in that the tertiary figurative element constitutes a foreground, preferably a frame, more preferably a background.

7. A figurative print according to any of the preceding claims, characterised in that the print is made of a curable, liquid printing ink, that the ink is applied on the plane print carrier in a liquid state, and that the ink is cured on the plane print carrier.

8. A figurative print according to any of the preceding claims, characterised in that the print is made by printing on a carrying medium and that the carrying medium is laid on the plane print carrier.

9. A method according to any of the preceding claims, characterised in that the plane print carrier is a ground surface such as a lawn, a slope along a road, a yard, or a parking lot.

10. Use of a figurative print according to any of the preceding claims for use as informative print, preferably as advertising print.
